(19) United States
(12) Patent Application Publication
(10) Pub. No.: US 2020/0098393 A1
(43) Pub. Date: Mar. 26, 2020

(54) MAGNETIC RECORDING MEDIUM PROCESSING DEVICE

(71) Applicant: NIDEC SANKYO CORPORATION, NAGANO (JP)

(72) Inventor: Yohei SHIMIZU, Nagano (JP)

(73) Assignee: NIDEC SANKYO CORPORATION, NAGANO (JP)

(21) Appl. No.: 16/583,265

(22) Filed: Sep. 26, 2019

(30) Foreign Application Priority Data
Sep. 26, 2018 (JP) 2018-180045

(51) Int. Cl. G11B 20/00; G11B 5/008; G11B 17/04; G11B 21/00; G11B 33/14

(52) U.S. Cl. CPC G11B 20/00188; G11B 5/00808; G11B 33/1493; G11B 21/003; G11B 17/0408

(57) ABSTRACT

Provided is a magnetic recording medium processing device including a loading slot into which a magnetic recording medium, a medium movement path extending from the loading slot, a first magnetic head arranged in the medium movement path and detecting a magnetic signal from the magnetic recording medium, a magnetic information reproducer reproducing the magnetic information, based on a signal of a specific frequency included in analog signals output from the first magnetic head, an interfering magnetic field generator generating an interfering magnetic field along the medium movement path, and an interfering magnetic field controller controlling the interfering magnetic field generator to generate a first interfering magnetic field until the first magnetic head starts detecting the magnetic signal, and controlling the interfering magnetic field generator to generate a second interfering magnetic field different in frequency spectrum from the first interfering magnetic field while the first magnetic head detects the magnetic signal.

### CROSS-REFERENCE TO RELATED APPLICATION

This application claims the priority benefits of Japan Patent Application No. 2018-180045, filed on Sep. 26, 2018. The entirety of the above-mentioned patent application is hereby incorporated by reference herein and made a part of this specification.

### BACKGROUND

### Field of the Invention

At least an embodiment of the present invention relates to a magnetic recording medium processing device that reproduces magnetic information from a magnetic recording medium on which the magnetic information is recorded.

### Description of the Related Documents

In a magnetic recording medium processing device, when a magnetic recording medium on which magnetic information is recorded moves along a medium movement path from a loading slot, a magnetic head reproduces the magnetic information, and further, writes the magnetic information to the magnetic recording medium. In such a magnetic recording medium processing device, a skimmer may be provided near the loading slot for the magnetic recording medium, and an unauthorized act of illegally acquiring the magnetic information may be performed. As a measure against such unauthorized act, there is proposed a technique for generating an interfering magnetic field near the loading slot to interfere with unauthorized reading of the magnetic information (see Japanese Patent Application Publication No. 2016-184292, hereinafter, referred to as Patent Literature 1). In a magnetic recording medium processing device described in Patent Literature 1, the interfering magnetic field is intermittently generated, and a period during which the generation of the interfering magnetic field is suspended is utilized to allow a pre-head provided near the loading slot to detect whether the magnetic information is recorded on the magnetic recording medium.

However, the technique described in Patent Literature 1 is not effective against an unauthorized act in which a skimmer is arranged somewhere in the medium movement path to illegally acquire the magnetic information. Therefore, the interfering magnetic field may be generated along the medium movement path, but in this case, the following problems may arise. In the medium movement path, a magnetic signal is detected by the magnetic head from the magnetic recording medium and the magnetic information is reproduced from the magnetic signal, and thus, if the interfering magnetic field is generated along the medium movement path, the reproduction of the magnetic information from the magnetic signal may be difficult. On the other hand, the time required to reproduce the magnetic information from the magnetic signal is longer than the time required to detect whether the magnetic information is recorded on the magnetic recording medium, and thus, if the generation of the interfering magnetic field is suspended during the time period during which the magnetic information is reproduced from the magnetic signal, the security is weakened.

In view of the above problems, it is an object of at least an embodiment of the present invention to provide a magnetic recording medium processing device capable of suppressing magnetic information from being unauthorizedly acquired in a medium movement path.

### SUMMARY

To solve the above problems, a magnetic recording medium processing device according to at least an embodiment of the present invention includes a loading slot into which a magnetic recording medium on which magnetic information is recorded is loaded, a medium movement path extending from the loading slot, a first magnetic head arranged in the medium movement path and configured to detect a magnetic signal from the magnetic recording medium, a magnetic information reproducer configured to reproduce the magnetic information, based on a signal of a specific frequency included in analog signals output from the first magnetic head, an interfering magnetic field generator configured to generate an interfering magnetic field along the medium movement path, and an interfering magnetic field controller configured to control the interfering magnetic field generator to generate a first interfering magnetic field until the first magnetic head starts detecting the magnetic signal, and control the interfering magnetic field generator to generate a second interfering magnetic field different in frequency spectrum from the first interfering magnetic field while the first magnetic head detects the magnetic signal.

In at least an embodiment of the present invention, the interfering magnetic field is generated along the medium movement path even while the first magnetic head detects the magnetic signal, and thus, even if an unauthorized act such as arranging a skimmer in the medium movement path is conducted, it is possible to prevent the magnetic information from being illegally acquired. Further, the interfering magnetic field controller controls the interfering magnetic field generator to generate the first interfering magnetic field until the first magnetic head starts detecting the magnetic signal and controls the interfering magnetic field generator to generate the second interfering magnetic field different in frequency spectrum from the first interfering magnetic field while the first magnetic head detects the magnetic signal, and thus, if a signal process corresponding to a difference in frequency spectrum between the first interfering magnetic field and the second interfering magnetic field is performed, it is possible to appropriately reproduce the magnetic information.

In at least an embodiment of the present invention, it is possible to adopt an aspect that the first interfering magnetic field has a frequency spectrum in which peaks appear in both a first frequency range including the specific frequency and a second frequency range not including the specific frequency, and the second interfering magnetic field has a frequency spectrum in which a peak appears in a frequency range not including the specific frequency. According to such an aspect, in response to a configuration that the magnetic information is reproduced, based on a signal of the specific frequency included in the analog signals output from the first magnetic head, the magnetic information reproducer generates the second interfering magnetic field of a frequency range not including the specific frequency, while the first magnetic head detects the magnetic signal, and thus, the magnetic information can be reproduced relatively easily.

In at least an embodiment of the present invention, it is possible to adopt an aspect that the magnetic recording medium processing device may further include a medium position detection mechanism including a sensor configured to detect a position of the magnetic recording medium moving along the medium movement path, and the interfering magnetic field controller may switch the interfering magnetic field generated by the interfering magnetic field generator between the first interfering magnetic field and the second interfering magnetic field, based on a detection result of the medium position detection mechanism.

In at least an embodiment of the present invention, it is possible to adopt an aspect that the interfering magnetic field controller generates, as the second interfering magnetic field, an interfering magnetic field of the second frequency range in the interfering magnetic field generator.

In at least an embodiment of the present invention, it is possible to adopt an aspect that the magnetic recording medium processing device further includes a second magnetic head arranged on a side closer to the loading slot of the medium movement path relative to the first magnetic head, and a magnetic information presence detector configured to detect whether magnetic information is recorded on the magnetic recording medium, based on a signal output from the second magnetic head, wherein the interfering magnetic field controller controls the interfering magnetic field generator to intermittently generate the first interfering magnetic field, when the magnetic recording medium is loaded into the loading slot, and the magnetic information presence detector detects whether the magnetic information is recorded on the magnetic recording medium, based on the signal output from the second magnetic head in a period during which generation of the first interfering magnetic field is suspended. The time required to detect whether the magnetic information is recorded on the magnetic recording medium is shorter than the time required to detect the presence of the magnetic information because it is sufficient to simply acquire a part of the magnetic signal from the magnetic recording medium. Therefore, even if a period during which the generation of the interfering magnetic field is suspended is provided, the security is not likely to be greatly reduced. Instead, it is possible to provide an advantage that at least an embodiment of the present invention can be realized with a relatively simple circuit configuration resulting from a configuration in which the presence of the magnetic information is detected in a period during which the generation of the interfering magnetic field is suspended.

In at least an embodiment of the present invention, it is possible to adopt an aspect that the magnetic information reproducer includes a filter through which the signal of the specific frequency, among the analog signals, is selectively passed, and the magnetic information reproducer reproduces the magnetic information based on the analog signal having passed through the filter.

In at least an embodiment of the present invention, it is possible to adopt an aspect that the magnetic information reproducer performs a filtering process of converting the analog signals into digital signals and then reproducing the magnetic information based on a digital signal corresponding to the signal of the specific frequency.

In at least an embodiment of the present invention, the interfering magnetic field is generated along the medium movement path even while the first magnetic head detects the magnetic signal, and thus, even if an unauthorized act such as arranging a skimmer in the medium movement path is conducted, it is possible to prevent the magnetic information from being illegally acquired. Further, the interfering magnetic field controller controls the interfering magnetic field generator to generate the first interfering magnetic field until the first magnetic head starts detecting the magnetic signal and controls the interfering magnetic field generator to generate the second interfering magnetic field different in frequency spectrum from the first interfering magnetic field while the first magnetic head detects the magnetic signal, and thus, if a signal process corresponding to a difference in frequency spectrum between the first interfering magnetic field and the second interfering magnetic field is performed, it is possible to appropriately reproduce the magnetic information.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an explanatory view schematically illustrating a configuration of a magnetic recording medium processing device according to at least an embodiment of the present invention;

FIG. 2 is a block diagram illustrating a configuration of the magnetic recording medium processing device according to at least an embodiment of the present invention;

FIG. 3 is a flowchart illustrating a basic operation of the magnetic recording medium processing device illustrated in FIG. 1;

FIG. 4 shows frequency spectrums of an interfering magnetic field or the like generated from an interfering magnetic field generator illustrated in FIG. 1;

FIG. 5 is a chart schematically showing a step of reproducing, by a first magnetic head illustrated in FIG. 1, magnetic information from a magnetic recording medium;

FIG. 6 is an explanatory view of a magnetic information reproducer illustrated in FIG. 2; and

FIG. 7 is a chart schematically showing a step of detecting, by a second magnetic head illustrated in FIG. 1, whether the magnetic information is recorded on the magnetic recording medium.

### DETAILED DESCRIPTION

With reference to the drawings, an embodiment of a magnetic recording medium processing device 1 to which the present invention is applied will be described.

### Overall Configuration

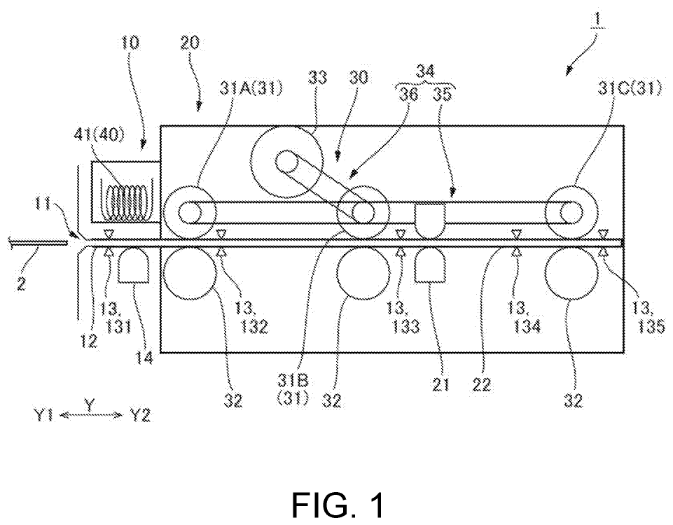

FIG. 1 is an explanatory view schematically illustrating a configuration of the magnetic recording medium processing device 1 according to at least an embodiment of the present invention. In the magnetic recording medium processing device 1 illustrated in FIG. 1, when a magnetic recording medium 2 such as a card on which magnetic information is recorded moves from a loading slot 11 along a medium movement path 22, the magnetic information is reproduced by a first magnetic head 21, for example. Therefore, the first magnetic head 21 includes a magnetic sensor configured to sense magnetic data of the loaded magnetic recording medium 2. In the present embodiment, the first magnetic head 21 also writes magnetic information to the magnetic recording medium 2.

The magnetic recording medium processing device 1 includes a gate part 10 provided with the loading slot 11 and a device main body 20 provided with the first magnetic head 21. Inside the device main body 20, a medium movement path 22 extending from the loading slot 11 is formed, and the first magnetic head 21 is arranged to face the medium movement path 22. The gate part 10 is provided with the loading slot 11 and a loading path 12 being a part of the medium movement path 22, the loading path 12 being located on a side of the loading slot 11. The device main body 20 includes a transport mechanism 30 configured to transport the magnetic recording medium 2 along the medium movement path 22. Further, the magnetic recording medium processing device 1 includes a medium position detection mechanism 13 provided with a plurality of sensors (a first sensor 131, a second sensor 132, a third sensor 133, a fourth sensor 134, and a fifth sensor 135) configured to detect a position of the magnetic recording medium 2 moving along the medium movement path 22. Examples of the above-mentioned sensor include a contact-type sensor provided with a sensing member in contact with the loaded magnetic recording medium 2 or an optical-type sensor.

The gate part 10 protrudes from a front surface of the device main body 20 toward a front Y1. The loading slot 11 is provided on the front surface of the gate part 10 and extends in a width direction. The gate part 10 includes the first sensor 131 of the medium position detection mechanism 13 and a second magnetic head 14 serving as a pre-head, in the vicinity of the loading slot 11. The first sensor 131 senses that the magnetic recording medium 2 is loaded into the loading slot 11. The second magnetic head 14 includes a magnetic sensor configured to sense whether the magnetic information is recorded on the loaded magnetic recording medium 2.

An interfering magnetic field generator 40 is arranged inside the gate part 10, and the interfering magnetic field generator 40 includes a coil 41 for generating an interfering magnetic field. The interfering magnetic field generator 40 generates an interfering magnetic field by energization to the coil 41. In the present embodiment, the interfering magnetic field generator 40 generates the interfering magnetic field toward the outside of the loading slot 11 (front Y1 of the loading slot 11) and generates the interfering magnetic field along the medium movement path 22.

The transport mechanism 30 performs an operation of receiving the magnetic recording medium 2 from the loading slot 11 to the medium movement path 22 and an operation of ejecting the magnetic recording medium 2 from the medium movement path 22 via the loading slot 11. In the present embodiment, the transport mechanism 30 includes a transport roller 31 configured to transport the magnetic recording medium 2 while contacting the magnetic recording medium 2, a pressure roller 32 configured to press the magnetic recording medium 2 against the transport roller 31, a motor 33 being a driving source, and a driving force transmission mechanism 34 configured to transmit a rotation of the motor 33 to the transport roller 31. A plurality of transport rollers 31 are arranged at predetermined intervals in a front-rear direction Y along the medium movement path 22. Each of the plurality of transport rollers 31 opposes the pressure roller 32 with the medium movement path 22 being interposed therebetween. The driving force transmission mechanism 34 includes a first belt mechanism 35 configured to hang a belt over a pulley attached to a rotation shaft of each of the transport rollers 31, and a second belt mechanism 36 configured to transmit a rotation of the motor 33 to one of the pulleys of the first belt mechanism 35. It is noted that the driving force transmission mechanism 34 is not limited to such a configuration, and may be modified where appropriate.

The plurality of transport rollers 31 include transport rollers 31A, 31C, and 31B. Of the plurality of transport rollers 31, the transport roller 31A located farthest in a front Y1 direction is arranged at a front end of the medium movement path 22. At a rear Y2 of the transport roller 31A, the transport rollers 31B and 31C are arranged in this order. The first magnetic head 21 is arranged between the transport rollers 31B and 31C. It is noted that the number of transport rollers 31 may not necessarily be three, and an arrangement of the transport rollers 31 is not limited to that as illustrated in FIG. 1. Further, a mechanism other than the transport roller can be used for the transport mechanism 30. For example, the magnetic recording medium 2 can also be transported by a belt mechanism. The transport mechanism 30 can switch transport directions, transport speeds, and the like of the magnetic recording medium 2 by controlling the rotation direction and the rotation speed of the motor 33.

### Configuration of Control System, etc.

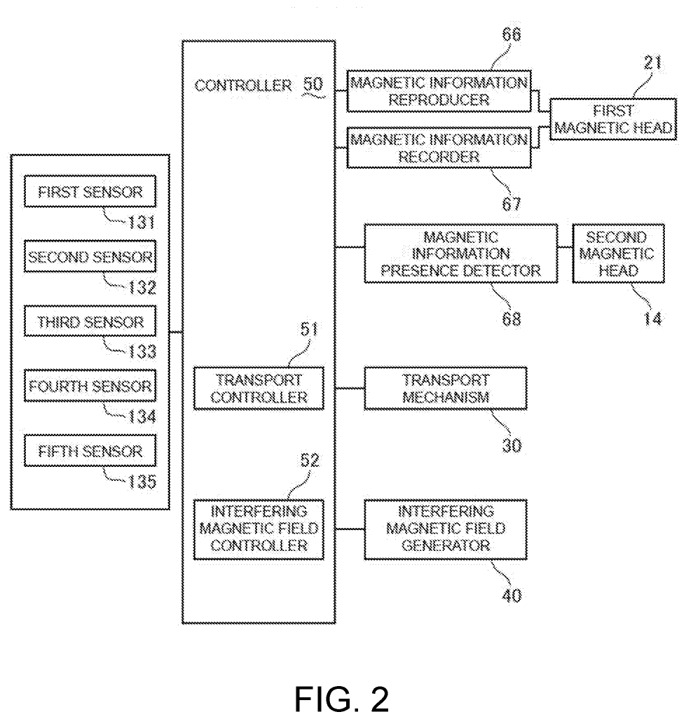

FIG. 2 is a block diagram illustrating a configuration of the magnetic recording medium processing device 1 according to at least an embodiment of the present invention. The magnetic recording medium processing device 1 includes a controller 50 including a CPU and the like, and the controller 50 performs a predetermined operation according to a program stored in advance in a memory or the like. The controller 50 includes a transport controller 51 configured to control the transport mechanism 30 and an interfering magnetic field controller 52 configured to control the generation of the interfering magnetic field in the interfering magnetic field generator 40, based on a detection result of the medium position detection mechanism 13. In the controller 50, the transport controller 51, the interfering magnetic field controller 52, and the like operate based on the detection result of the medium position detection mechanism 13. For example, when an output of the first sensor 131 switches from a signal indicating absence of the magnetic recording medium to a signal indicating presence of the magnetic recording medium, the transport controller 51 controls the motor 33 of the transport mechanism 30 to start driving at a low-speed rotation speed to start transporting the magnetic recording medium 2, and the interfering magnetic field controller 52 commands the interfering magnetic field generator 40 to generate the interfering magnetic field.

Further, the magnetic recording medium processing device 1 includes a magnetic information reproducer 66 configured to reproduce the magnetic information recorded on the magnetic recording medium 2, based on the detection result of the first magnetic head 21, and a magnetic information recorder (magnetic information writer) 67 configured to write the magnetic information into the magnetic recording medium 2 by the first magnetic head 21. Further, the magnetic recording medium processing device 1 includes a magnetic information presence detector 68 configured to detect whether the magnetic information is recorded on the magnetic recording medium 2, based on the detection result of the second magnetic head 14. Therefore, in the present embodiment, upon sensing by the second magnetic head 14 and the magnetic information presence detector 68 that the magnetic information is recorded on the magnetic recording medium 2, the transport of the magnetic recording medium 2 and the energization to the coil 41 can be started. According to such a configuration, it is not necessary to provide the first sensor 131, and it is possible to generate the interfering magnetic field only when the loaded magnetic recording medium 2 is a magnetic recording medium.

### Basic Operation

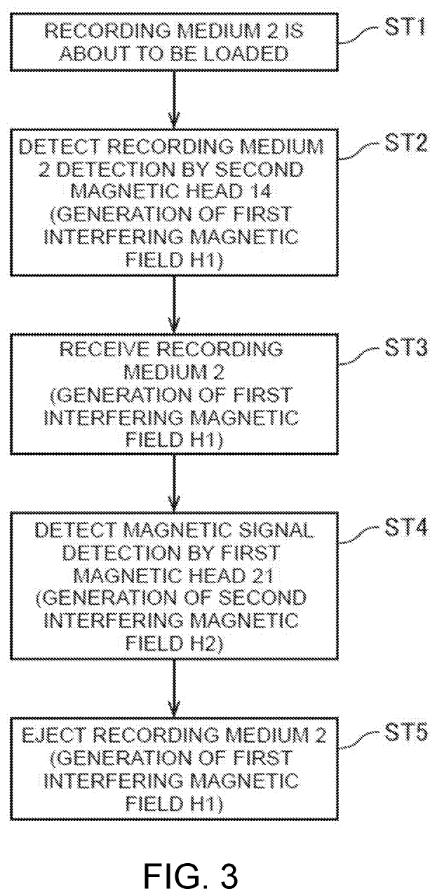

FIG. 3 is a flowchart illustrating a basic operation of the magnetic recording medium processing device 1 illustrated in FIG. 1. As illustrated in FIG. 1, FIG. 2, and FIG. 3, in the magnetic recording medium processing device 1 of the present embodiment, in a state where the magnetic recording medium 2 is about to be loaded (step ST1), if the controller 50 detects by the first sensor 131 that the magnetic recording medium 2 is loaded, the transport controller 51 of the controller 50 controls the transport mechanism 30 to introduce the magnetic recording medium 2 into the device main body 20 (step ST2). At that time, the controller 50 uses the second magnetic head 14 and the magnetic information presence detector 68 to determine whether the magnetic information is recorded on the magnetic recording medium 2. If the magnetic information is recorded on the magnetic recording medium 2, the transport controller 51 of the controller 50 controls the transport mechanism 30 to further receive the magnetic recording medium 2 into the device main body 20 (step ST3).

Next, if the third sensor 133 detects an end of the magnetic recording medium 2, the first magnetic head 21 reads the magnetic data of the magnetic recording medium 2, and the magnetic information reproducer 66 reproduces the magnetic information (step ST4). Such an operation is performed until the fourth sensor 134 detects the end of the magnetic recording medium 2, and if the fourth sensor 134 detects the end of the magnetic recording medium 2, the reading of the magnetic data by the first magnetic head 21 ends.

Subsequently, if the fifth sensor 135 detects the end of the magnetic recording medium 2, the transport controller 51 of the controller 50 controls the transport mechanism 30 to stop the transport of the magnetic recording medium 2, and then, performs an ejection operation of transporting the magnetic recording medium 2 toward the loading slot 11 (step ST5). In the ejection operation, if the second sensor 132 detects the end of the magnetic recording medium 2, the controller 50 determines that the magnetic recording medium 2 is returned to the loading slot 11 and stops the transport of the magnetic recording medium 2. Therefore, a user can hold a tip end portion of the magnetic recording medium 2 protruding from the loading slot 11 to remove the magnetic recording medium 2. Further, the controller 50 uses the first sensor 131 to determine whether the removal of the magnetic recording medium 2 is completed, and upon detection that the removal of the magnetic recording medium 2 is completed, a series of operations are completed, and then, the process returns again to the state where the recording medium is about to be inserted (step ST1).

### Configuration of Interfering Magnetic Field

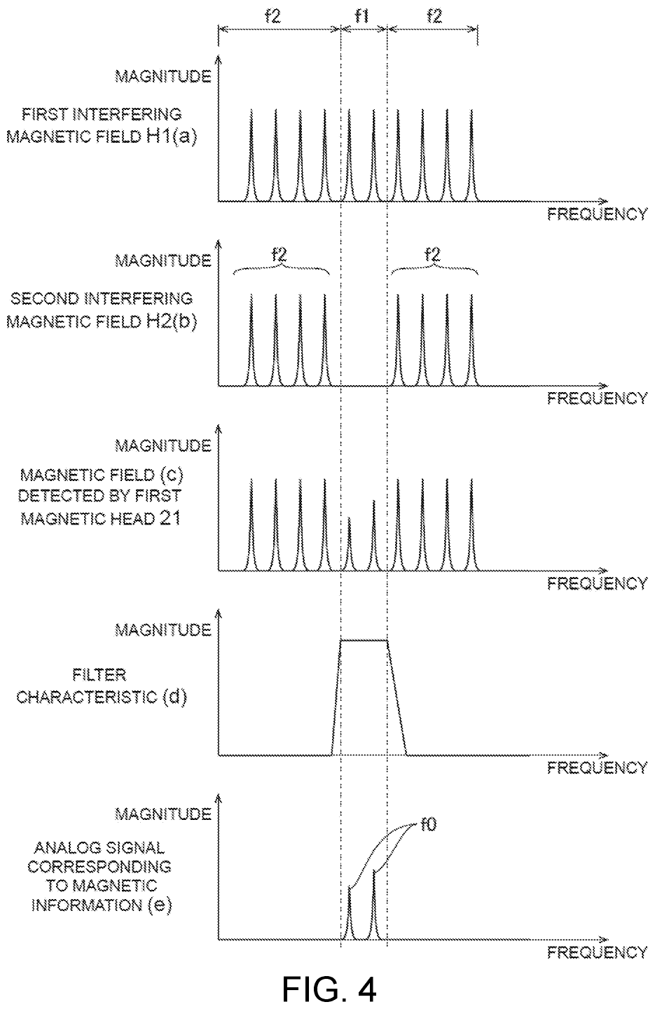

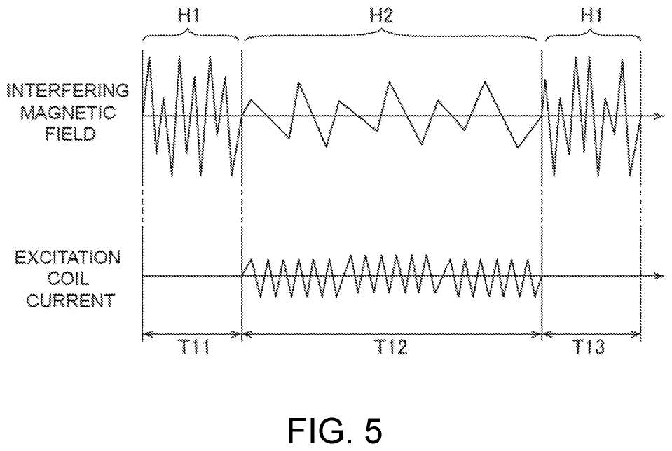

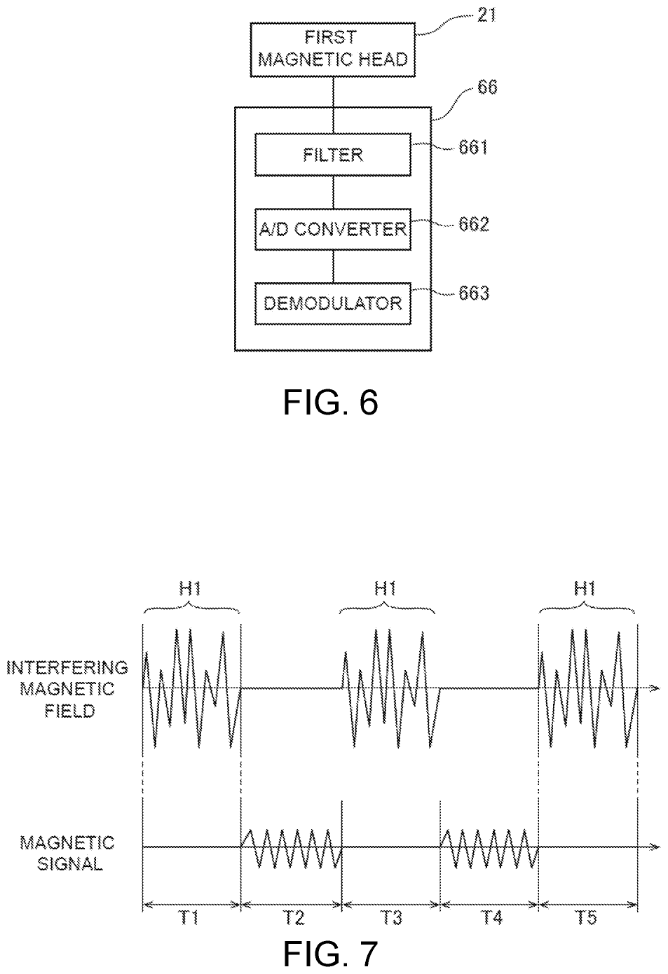

FIG. 4 is frequency spectrums for explaining the interfering magnetic field or the like generated from the interfering magnetic field generator 40 illustrated in FIG. 1. In FIG. 4, a frequency spectrum (a) of a first interfering magnetic field H1, a frequency spectrum (b) of a second interfering magnetic field H2, a frequency spectrum (c) of a detected magnetic field in the first magnetic head 21, a filter characteristic (d) thereof, and a frequency spectrum (e) of an analog signal corresponding to the magnetic information, are schematically shown, respectively. FIG. 5 is a chart schematically showing a step of reproducing, by the first magnetic head 21 illustrated in FIG. 1, the magnetic information from the magnetic recording medium 2, where an upper part schematically shows the interfering magnetic field and a lower part schematically shows a signal detected via the first magnetic head 21. FIG. 6 is an explanatory diagram of the magnetic information reproducer 66 illustrated in FIG. 2. It is noted that the frequency spectrum and the like of the interfering magnetic field illustrated in FIG. 4, FIG. 5 and FIG. 7 described later are merely examples, and at least an embodiment of the present invention is not limited to the modes illustrated in FIG. 4, FIG. 5, and FIG. 7.

In the present embodiment, in the magnetic recording medium processing device 1, when the operation described with reference to FIG. 3 is performed, if a skimmer is arranged in the medium movement path 22, the magnetic information is illegally acquired from the magnetic recording medium 2, and thus, the interfering magnetic field controller 52 of the controller 50 controls the interfering magnetic field generator 40 to generate an interfering magnetic field described below, in a period of the steps ST2 to ST5 illustrated in FIG. 3.

In the present embodiment, the magnetic information reproducer 66 reproduces the magnetic information, based on a signal of a specific frequency included in the analog signal output from the first magnetic head 21. Here, a specific frequency f0 of the analog signal corresponding to the magnetic information appears in a first frequency range f1 in a frequency spectrum (e) illustrated in FIG. 4, for example. In the present embodiment, the magnetic information is recorded on an F2F format on the magnetic recording medium 2, and thus, signals of two specific frequencies f0 are included in the first frequency range f1 from 1 kHz to 4 kHz.

In such a configuration, the interfering magnetic field controller 52 controls the interfering magnetic field generator 40 to generate the first interfering magnetic field H1, in a period (period T11 illustrated in FIG. 5) from the step ST2 where the magnetic recording medium 2 is loaded into the loading slot 11 to the step ST3 where the first magnetic head 21 starts detecting the magnetic signal. As can be seen from the frequency spectrum (a) illustrated in FIG. 4, the first interfering magnetic field H1 has a frequency spectrum where peaks appear in both the first frequency range f1 including the specific frequency f0 and a second frequency range f2 not including the specific frequency f0.

Further, in step ST4, the interfering magnetic field controller 52 controls the interfering magnetic field generator 40 to generate the second interfering magnetic field H2 different in frequency spectrum from the first interfering magnetic field H1, in a period (period T12 illustrated in FIG. 5) during which the first magnetic head 21 detects the magnetic signal. In the present embodiment, the second interfering magnetic field H2 has a frequency spectrum in which a peak appears in a frequency range not including the specific frequency f0. More specifically, as can be seen from the frequency spectrum (b) illustrated in FIG. 4, the interfering magnetic field controller 52 controls to generate, as the second interfering magnetic field H2, the interfering magnetic field of a second frequency range f2 included in the first interfering magnetic field H1.

Therefore, when the first magnetic head 21 detects the magnetic signal, as can be seen from the frequency spectrum (c) illustrated in FIG. 4, the first magnetic head 21 detects a signal of the specific frequency f0 corresponding to the magnetic information together with a signal having the frequency spectrum of the second frequency range f2 of the second interfering magnetic field H2.

However, as illustrated in FIG. 6, the magnetic information reproducer 66 includes a filter 661 having a filter characteristic (filter characteristic (d) illustrated in FIG. 4) for selectively passing the signal of the specific frequency f0 among the analog signals output from the first magnetic head 21. The magnetic information reproducer 66 reproduces the magnetic information, based on the analog signal (frequency spectrum (e) illustrated in FIG. 4) having passed through the filter 661. More specifically, the magnetic information reproducer 66 includes an A/D converter 662 configured to convert the analog signal having passed through the filter 661 into a digital signal, and a demodulator 663 configured to demodulate the magnetic information, based on the digital signal output from the A/D converter 662. Therefore, when the first magnetic head 21 detects the magnetic signal, the magnetic information reproducer 66 can reproduce the magnetic information even if the second interfering magnetic field H2 (second frequency range f2) is output.

In the present embodiment, after the first magnetic head 21 detects the magnetic signal, the interfering magnetic field generator 40 is controlled to generate the first interfering magnetic field H1 in step ST5 (period T13 illustrated in FIG. 5) until the magnetic recording medium 2 is ejected.

It is noted that the frequency spectrum in the second frequency range f2 of the first interfering magnetic field H1 and the frequency spectrum in the second frequency range f2 of the second interfering magnetic field H2 may be the same or different from each other. Further, in the first interfering magnetic field H1 and the second interfering magnetic field H2, the frequency spectrum or the intensity may be the same even if a time passes, or the frequency spectrum or the intensity may change with an elapse of time. Further, regardless of the loading of the magnetic recording medium 2, the first interfering magnetic field H1 may be constantly generated.

### Detection Step by Second Magnetic Head 14

FIG. 7 is a chart schematically showing a step of detecting, by the second magnetic head 14 illustrated in FIG. 1, whether the magnetic information is recorded on the magnetic recording medium 2, where an upper part schematically shows the interfering magnetic field and a lower part schematically shows a signal detected via the first magnetic head 21. As illustrated in FIG. 7, in step ST 2, in a step of detecting, by the second magnetic head 14, whether the magnetic information is recorded on the magnetic recording medium 2, the interfering magnetic field controller 52 controls to intermittently generate the first interfering magnetic field H1. Accordingly, the magnetic information presence detector 68 suspends the detection by the second magnetic head 14 in the periods T1, T3, and T5 during which the first interfering magnetic field H1 is generated, and performs the detection by the second magnetic head 14 in the periods T2 and T4 during which the generation of the first interfering magnetic field H1 is suspended.

### Main Effect of Present Embodiment

As described above, in the magnetic recording medium processing device 1 according to the present embodiment, even while which the first magnetic head 21 detects the magnetic signal after the magnetic recording medium 2 is loaded into the loading slot 11, the first interfering magnetic field H1 is generated along the medium movement path 22, and thus, even if an unauthorized act such as arranging a skimmer in the medium movement path 22 is conducted, it is possible to prevent the magnetic information from being illegally acquired. In addition, based on the configuration that the magnetic information is reproduced based on the signal of the specific frequency f0 included in the analog signal output from the first magnetic head 21, the magnetic information reproducer 66 generates the second interfering magnetic field H2 of the frequency range not including the specific frequency f0 while the first magnetic head 21 detects the magnetic signal, and thus, it is possible to properly reproduce the magnetic information.

Further, on a side closer to the loading slot 11 of the medium movement path 22 relative to the first magnetic head 21, whether the magnetic information is recorded on the magnetic recording medium 2 is detected by the second magnetic head 14. At the time of such detection, the interfering magnetic field generator 40 intermittently generates the first interfering magnetic field H1, and the magnetic information presence detector 68 detects whether the magnetic information is recorded on the magnetic recording medium 2, based on the signal output from the second magnetic head 14 in the period during which the generation of the first interfering magnetic field H1 is suspended. The time required to detect whether the magnetic information is recorded on the magnetic recording medium 2 is shorter than the time required to detect the presence of the magnetic information because it is sufficient to simply acquire a part of the magnetic signal from the magnetic recording medium 2. Therefore, even if the period during which the generation of the first interfering magnetic field H1 is suspended is provided, the security may not be greatly weakened. Instead, with the configuration where the presence of the magnetic information is detected in the period during which the generation of the first interfering magnetic field H1 is suspended, there is an advantageous that at least an embodiment of the present invention can be achieved with a relatively simple circuit configuration.

### Another Embodiment

In the above-described embodiment, an aspect is adopted in which the magnetic information reproducer 66 reproduces the magnetic information, based on the analog signal having passed through the filter 661, however an aspect may be adopted in which the magnetic information reproducer 66 may perform a filtering process by software. That is, an aspect may be adopted in which after converting the analog signal into the digital signal, the magnetic information reproducer 66 may reproduce the magnetic information, based on the digital signal corresponding to the signal of the specific frequency f0.

In the above embodiment, the second interfering magnetic field H2 has the frequency spectrum in which the peak appears in the frequency range not including the specific frequency f0, and if the second interfering magnetic field H2 and the first interfering magnetic field H1 are different in frequency spectrum, the second interfering magnetic field H2 may have a frequency spectrum in which the peak appears in a frequency range including the specific frequency f0. Also in this case, if a signal process corresponding to the difference in the frequency spectrum between the first interfering magnetic field H1 and the second interfering magnetic field H2 is performed, the reproduction of the magnetic information can be properly performed. For example, if the magnetic information reproducer 66 sets an appropriate threshold value to the first frequency range f1 including the specific frequency f0 and reduces a signal caused by the second interfering magnetic field H2, the reproduction of the magnetic information is properly performed.

Further, an aspect may be adopted in which, similarly to the second interfering magnetic field H2 illustrated in FIG. 4, the first interfering magnetic field H1 also has the frequency spectrum in which the peak appears in the frequency range not including the specific frequency f0.

What is claimed is:

1. A magnetic recording medium processing device, comprising:
a loading slot into which a magnetic recording medium on which magnetic information is recorded is loaded;
a medium movement path extending from the loading slot;
a first magnetic head arranged in the medium movement path and configured to detect a magnetic signal from the magnetic recording medium;
a magnetic information reproducer configured to reproduce the magnetic information, based on a signal of a specific frequency included in analog signals output from the first magnetic head;
an interfering magnetic field generator configured to generate an interfering magnetic field along the medium movement path; and
an interfering magnetic field controller configured to control the interfering magnetic field generator to generate a first interfering magnetic field until the first magnetic head starts detecting the magnetic signal, and control the interfering magnetic field generator to generate a second interfering magnetic field different in frequency spectrum from the first interfering magnetic field while the first magnetic head detects the magnetic signal.

2. The magnetic recording medium processing device according to claim 1, wherein
the first interfering magnetic field has a frequency spectrum in which peaks appear in both a first frequency range including the specific frequency and a second frequency range not including the specific frequency, and
the second interfering magnetic field has a frequency spectrum in which a peak appears in a frequency range not including the specific frequency.

3. The magnetic recording medium processing device according to claim 2, wherein
the second interfering magnetic field has a frequency spectrum in which a peak appears in the second frequency range.

4. The magnetic recording medium processing device according to claim 1, further comprising:
a medium position detection mechanism including a sensor configured to detect a position of the magnetic recording medium moving along the medium movement path, wherein
the interfering magnetic field controller switches the interfering magnetic field generated by the interfering magnetic field generator between the first interfering magnetic field and the second interfering magnetic field, based on a detection result of the medium position detection mechanism.

5. The magnetic recording medium processing device according to claim 1, further comprising:
a second magnetic head arranged on a side closer to the loading slot of the medium movement path relative to the first magnetic head; and
a magnetic information presence detector configured to detect whether the magnetic information is recorded on the magnetic recording medium based on a signal output from the second magnetic head, wherein
the interfering magnetic field controller controls the interfering magnetic field generator to intermittently generate the first interfering magnetic field, when the magnetic recording medium is loaded into the loading slot, and
the magnetic information presence detector detects whether the magnetic information is recorded on the magnetic recording medium based on the signal output from the second magnetic head in a period during which generation of the first interfering magnetic field is suspended.

6. The magnetic recording medium processing device according to claim 1, wherein
the magnetic information reproducer includes a filter through which the signal of the specific frequency, among the analog signals, is selectively passed, and the magnetic information reproducer reproduces the magnetic information based on the analog signal having passed through the filter.

7. The magnetic recording medium processing device according to claim 1, wherein
the magnetic information reproducer performs a filtering process of converting the analog signals into digital signals, and then reproducing the magnetic information based on a digital signal corresponding to the signal of the specific frequency.

8. The magnetic recording medium processing device according to claim 3, further comprising:
a medium position detection mechanism including a sensor configured to detect a position of the magnetic recording medium moving along the medium movement path, wherein
the interfering magnetic field controller switches the interfering magnetic field generated by the interfering magnetic field generator between the first interfering magnetic field and the second interfering magnetic field, based on a detection result of the medium position detection mechanism.

9. The magnetic recording medium processing device according to claim 8, further comprising:
a second magnetic head arranged on a side closer to the loading slot of the medium movement path relative to the first magnetic head; and
a magnetic information presence detector configured to detect whether the magnetic information is recorded on the magnetic recording medium based on a signal output from the second magnetic head, wherein
the interfering magnetic field controller controls the interfering magnetic field generator to intermittently generate the first interfering magnetic field, when the magnetic recording medium is loaded into the loading slot, and
the magnetic information presence detector detects whether the magnetic information is recorded on the magnetic recording medium based on the signal output from the second magnetic head in a period during which generation of the first interfering magnetic field is suspended.

10. The magnetic recording medium processing device according to claim 9, wherein
the magnetic information reproducer includes a filter through which the signal of the specific frequency, among the analog signals, is selectively passed, and the magnetic information reproducer reproduces the magnetic information based on the analog signal having passed through the filter.

11. The magnetic recording medium processing device according to claim 9, wherein
the magnetic information reproducer performs a filtering process of converting the analog signals into digital signals, and then reproducing the magnetic information based on a digital signal corresponding to the signal of the specific frequency.

12. The magnetic recording medium processing device according to claim 2, further comprising:
a medium position detection mechanism including a sensor configured to detect a position of the magnetic recording medium moving along the medium movement path, wherein
the interfering magnetic field controller switches the interfering magnetic field generated by the interfering magnetic field generator between the first interfering magnetic field and the second interfering magnetic field, based on a detection result of the medium position detection mechanism.

13. The magnetic recording medium processing device according to claim 2, further comprising:
a second magnetic head arranged on a side closer to the loading slot of the medium movement path relative to the first magnetic head; and
a magnetic information presence detector configured to detect whether the magnetic information is recorded on the magnetic recording medium based on a signal output from the second magnetic head, wherein
the interfering magnetic field controller controls the interfering magnetic field generator to intermittently generate the first interfering magnetic field, when the magnetic recording medium is loaded into the loading slot, and
the magnetic information presence detector detects whether the magnetic information is recorded on the magnetic recording medium based on the signal output from the second magnetic head in a period during which generation of the first interfering magnetic field is suspended.

14. The magnetic recording medium processing device according to claim 2, wherein
the magnetic information reproducer includes a filter through which the signal of the specific frequency, among the analog signals, is selectively passed, and the magnetic information reproducer reproduces the magnetic information based on the analog signal having passed through the filter.

15. The magnetic recording medium processing device according to claim 2, wherein
the magnetic information reproducer performs a filtering process of converting the analog signals into digital signals, and then reproducing the magnetic information based on a digital signal corresponding to the signal of the specific frequency.

16. The magnetic recording medium processing device according to claim 3, further comprising:
a second magnetic head arranged on a side closer to the loading slot of the medium movement path relative to the first magnetic head; and
a magnetic information presence detector configured to detect whether the magnetic information is recorded on the magnetic recording medium based on a signal output from the second magnetic head, wherein
the interfering magnetic field controller controls the interfering magnetic field generator to intermittently generate the first interfering magnetic field, when the magnetic recording medium is loaded into the loading slot, and
the magnetic information presence detector detects whether the magnetic information is recorded on the magnetic recording medium based on the signal output from the second magnetic head in a period during which generation of the first interfering magnetic field is suspended.

17. The magnetic recording medium processing device according to claim 12, further comprising:
a second magnetic head arranged on a side closer to the loading slot of the medium movement path relative to the first magnetic head; and
a magnetic information presence detector configured to detect whether the magnetic information is recorded on the magnetic recording medium based on a signal output from the second magnetic head, wherein
the interfering magnetic field controller controls the interfering magnetic field generator to intermittently generate the first interfering magnetic field, when the magnetic recording medium is loaded into the loading slot, and
the magnetic information presence detector detects whether the magnetic information is recorded on the magnetic recording medium based on the signal output from the second magnetic head in a period during which generation of the first interfering magnetic field is suspended.

18. The magnetic recording medium processing device according to claim 4, further comprising:
a second magnetic head arranged on a side closer to the loading slot of the medium movement path relative to the first magnetic head; and
a magnetic information presence detector configured to detect whether the magnetic information is recorded on the magnetic recording medium based on a signal output from the second magnetic head, wherein
the interfering magnetic field controller controls the interfering magnetic field generator to intermittently generate the first interfering magnetic field, when the magnetic recording medium is loaded into the loading slot, and
the magnetic information presence detector detects whether the magnetic information is recorded on the magnetic recording medium based on the signal output from the second magnetic head in a period during which generation of the first interfering magnetic field is suspended.

19. The magnetic recording medium processing device according to claim 4, wherein
the magnetic information reproducer includes a filter through which the signal of the specific frequency, among the analog signals, is selectively passed, and the magnetic information reproducer reproduces the magnetic information based on the analog signal having passed through the filter.

20. The magnetic recording medium processing device according to claim 4, wherein
the magnetic information reproducer performs a filtering process of converting the analog signals into digital signals, and then reproducing the magnetic information based on a digital signal corresponding to the signal of the specific frequency.
